(19) United States
(12) Patent Application Publication
(10) Pub. No.: US 2019/0179587 A1
(43) Pub. Date: Jun. 13, 2019

(54) OPTICAL IMAGING DEVICE WITH BACKUP DISPLAY

(71) Applicant: Sitronix Technology Corp., Jhubei City (TW)

(72) Inventor: Chuan-Pin Hsiung, Jhubei City (TW)

(21) Appl. No.: 16/212,763

(22) Filed: Dec. 7, 2018

Related U.S. Application Data
(60) Provisional application No. 62/595,669, filed on Dec. 7, 2017.

(51) Int. Cl. G06F 3/14; G02B 27/01; B60K 35/00; B60K 37/02

(52) U.S. Cl. CPC G06F 3/1423; G02B 27/0101; B60K 35/00; B60K 2350/1068; B60K 2350/1072; B60K 2350/2052; B60K 37/02

(57) ABSTRACT

The present invention relates to an optical imaging device with backup display, which comprises a main display module and a backup display module. The main display module projects a first image to be a virtual image. The backup display module displays a second image, which is a real image. By using the backup display module to backup for displaying car status information, when the main display module is fails, the backup display module still can display the second image for displaying the car status information. Then the user can confirm the car status.

### FIELD OF THE INVENTION

The present invention relates generally to an optical imaging device, and particularly to an optical imaging device with backup display.

### BACKGROUND OF THE INVENTION

The applications of head-up displays (HUD) are extended form airplanes to automobiles. To enhance driving safety, the simple information provided by HUD is unable to meet car drivers' requirements. Consequently, the augmented reality (AR) for HUD has been developed, in which the car status information to be provided to the driver is overlapped with the road status as seen by the driver. The car status information includes insufficient safety distance, lane departure, lane change notification and is substantial to improving driving safety.

The modern trend is to gradually replace the car dashboard by HUD. Unfortunately, the quality and stability of car dashboard are extremely high. Contrarily, an HUD includes optical, mechanical, and power-consuming elements, for example, the China Patent Applications No. 201410453217.8 and No. 201380073633.9 and the U.S. Pat. No. 9,030,748, and hence making the stability of an HUD lower than the stability of a car dashboard. During the design process for replacing the car dashboard and becoming an important and the only safety information device, not only should the performance of the HUD be considered, but how to provide the driver with the basic car status information when the device fails is also extremely important for complying with international standards such as ISO26262 (Road Vehicles—Functional Safety).

Accordingly, the present invention provides an optical imaging device with backup display for solving the above technical shortcomings. The optical imaging device with backup display comprises a backup display module. Thereby, when the main display module is abnormal, the backup display module still can display the car status information.

### SUMMARY

An objective of the present invention is to provide an optical imaging device with backup display, which comprises a backup display module for displaying the real image. When the main display module is abnormal, the backup display module still can display the car status information.

The present invention relates to an optical imaging device with backup display, which comprises a housing, a main display module, and a backup display module. The main display module and the backup display module are disposed in the housing. The main display module projects a first image to be a virtual image. The backup display module displays a second image, which is a real image. Thereby, when the main display module is abnormal, the backup display module still can display the car status information.

### BRIEF DESCRIPTION OF THE DRAWINGS

FIG. 1A shows a stereoscopic diagram of the optical imaging device according to an embodiment of the present invention;

FIG. 1B shows a cross-sectional view of the optical imaging device according to an embodiment of the present invention;

FIG. 2 shows a control block diagram of the optical imaging device according to an embodiment of the present invention;

FIG. 3A shows a schematic diagram of the optical imaging device projecting images according to an embodiment of the present invention;

FIG. 3B shows a schematic diagram of the optical imaging device projecting images to the visual region according to an embodiment of the present invention;

FIG. 4A shows a stereoscopic diagram of the optical imaging device according to another embodiment of the present invention; and

FIG. 4B shows a cross-sectional view of the optical imaging device according to another embodiment of the present invention.

### DETAILED DESCRIPTION

In the specifications and subsequent claims, certain words are used for representing specific devices. A person having ordinary skill in the art should know that hardware manufacturers might use different nouns to call the same device. In the specifications and subsequent claims, the differences in names are not used for distinguishing devices. Instead, the differences in functions are the guidelines for distinguishing. In the whole specifications and subsequent claims, the word “comprising” is an open language and should be explained as “comprising but not limited to”. Besides, the word “couple” includes any direct and indirect electrical connection. Thereby, if the description is that a first device is coupled to a second device, it means that the first device is connected electrically to the second device directly, or the first device is connected electrically to the second device via other device or connecting means indirectly.

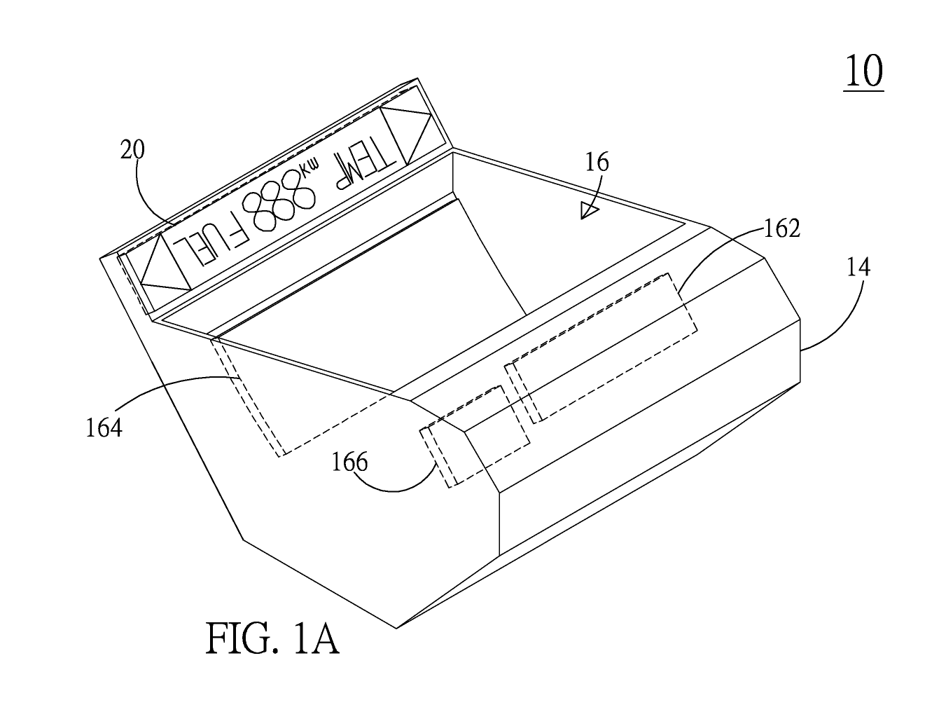

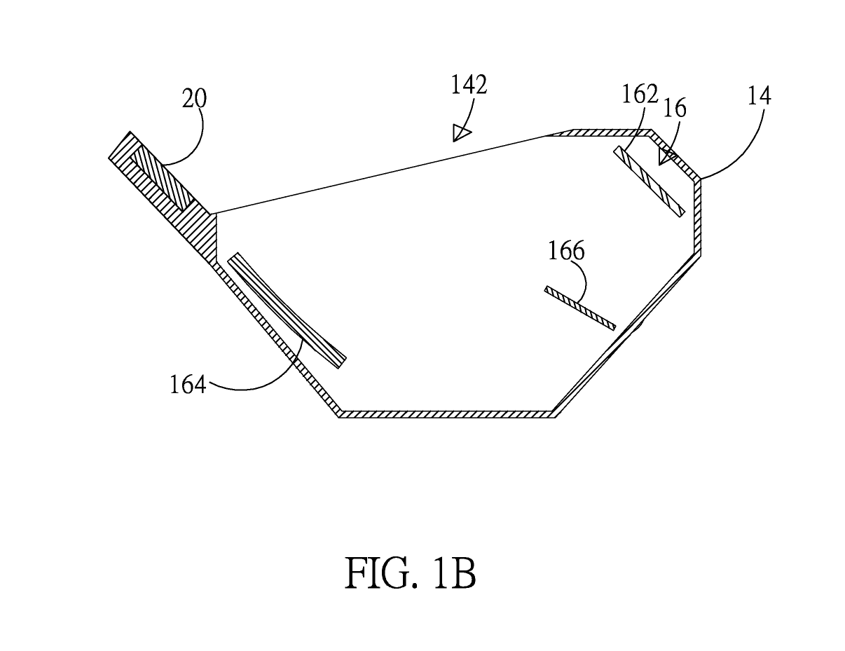

Please refer to FIG. 1A and FIG. 1B, which show a stereoscopic diagram and a cross-sectional view of the optical imaging device according to an embodiment of the present invention. As shown in FIG. 1A and FIG. 1B, the optical imaging device 10 according to the present embodiment comprises a housing 14, a main display module 16, and a backup display module 20. The housing 14 according to the present embodiment includes a display window 142. The main display module 16 according to the present embodiment includes a reflection mirror 162, an optical projection element 164, and a main display unit 166. The backup display module 20 is different from the main display module 16. The backup display module 20 displays real images directly, instead of reflecting or projecting images through optical elements. According to an embodiment of the present invention, the backup display module 20 may be a segment display, a dot-matrix display, or a simple liquid crystal display with backlight.

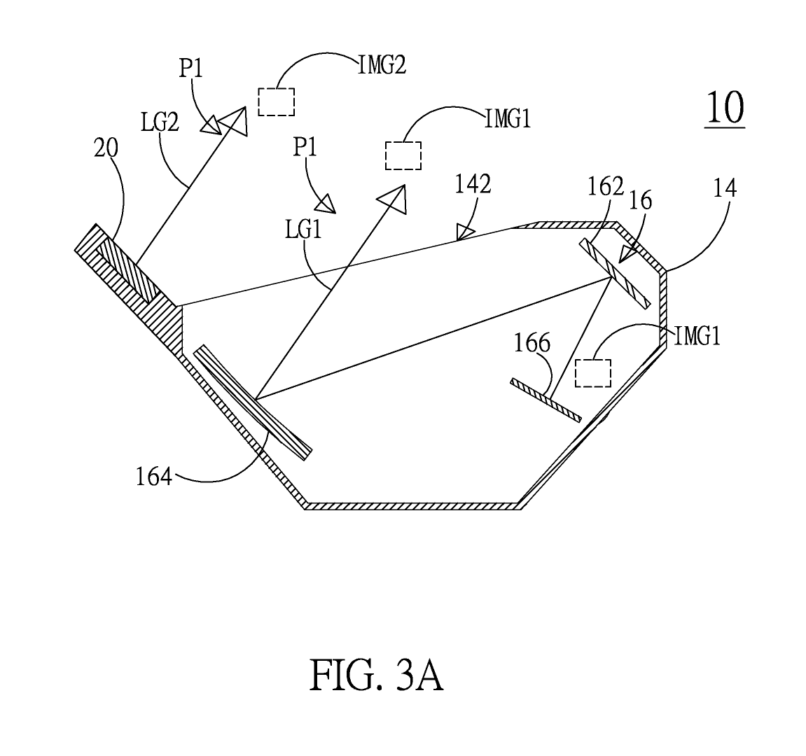

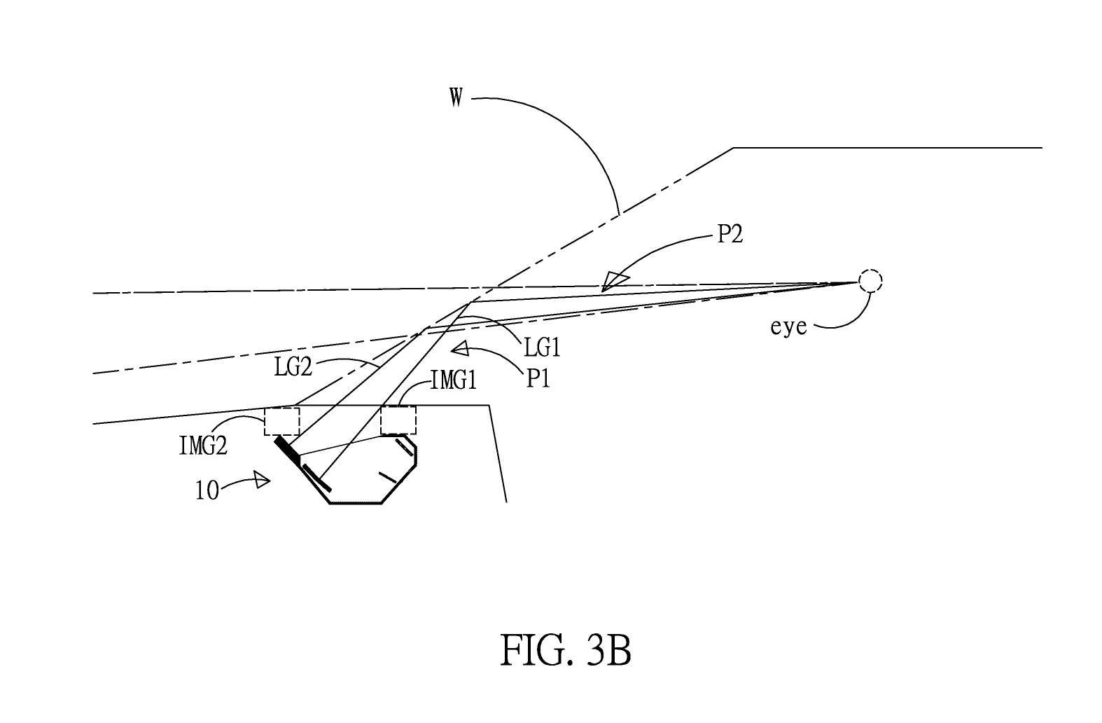

Please refer again to FIG. 1A and FIG. 1B. The main display module 16 is disposed in the housing 14 for projecting a first image IMG1, as shown in FIG. 3A. The reflection mirror 162, the optical projection element 164, and the main display unit 166 are all disposed in the housing 14. The main display unit 166 displays the first image IMG1; the reflection mirror 162 reflects the first image IMG1. Because the optical projection element 164 is located on the reflection path of the reflection mirror 162, the reflection mirror 162 reflects the first image IMG1 to the optical projection element 164 before the optical projection element 164 projects the first image IMG1. According to an embodiment of the present embodiment, the optical projection element 164 may be a spherical mirror, which may magnify the first image IMG1 reflected by the reflection mirror 162. Hence, a magnified reflected first image IMG1 will be provided. Alternatively, the optical projection element 164 may be a plane mirror, which may reflect the first image IMG1 directly. Because the first image IMG1 is reflected by the reflection mirror 162 and projected by the optical projection element 164, the main display module 16 projects the first image IMG1 to be a virtual image.

The backup display module 20 according to the present embodiment is disposed on one side of the display window 142 of the housing 14. It is also located on one side of the main display module 16. The backup display module 20 displays a second image IMG2, which is a real image, as shown in FIG. 3A. The second image IMG2 is not reflected by optical elements.

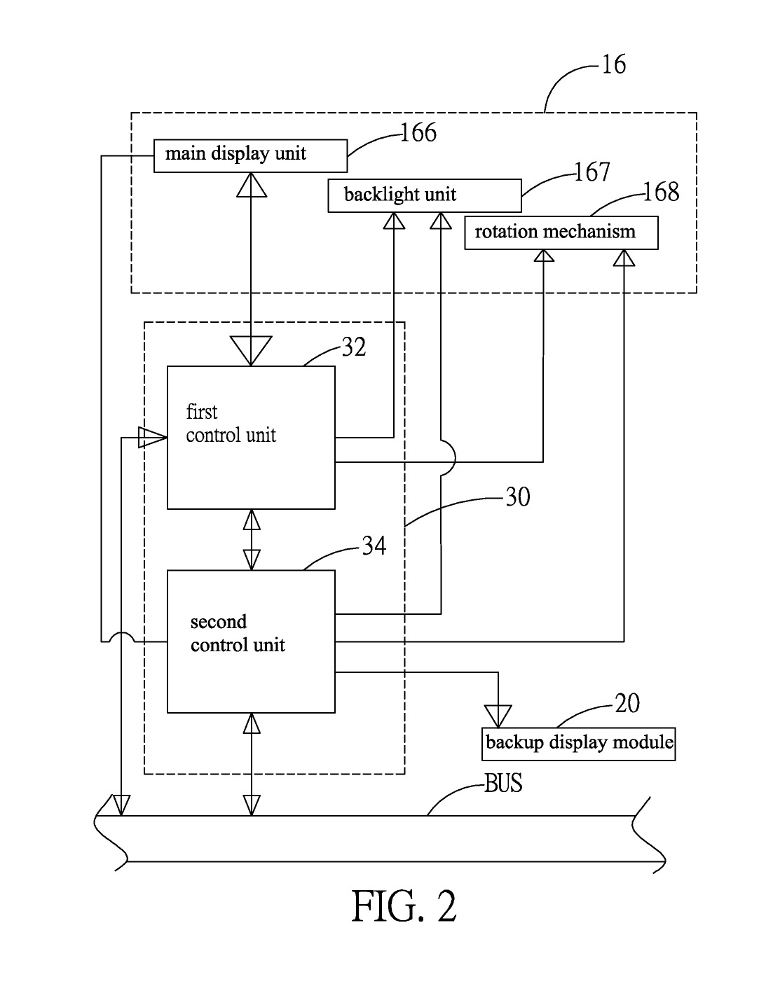

Please refer to FIG. 2, which shows a control block diagram of the optical imaging device according to an embodiment of the present invention. As shown in the figure, the main display module 16 may further include a backlight unit 167, which is disposed behind the main display unit 166 for providing backlight to the main display unit 166. In addition, the main display module 16 may further include a rotation mechanism 168, which is used for rotating the optical projection element 164 for adjusting the angle of projecting the first image IMG1. The optical imaging device 10 according to the present invention may further comprise a control circuit 30, which is coupled to the main display module 16 and the backup display module 20 for controlling the main display module 16 to project the first image IMG1 and for controlling the backup display module 20 to display the second image IMG2.

The control circuit 30 includes a first control unit 32 and a second control unit 34. The first control unit 32 is coupled to the main display unit 166, the backlight unit 167, and the rotation mechanism 168 of the main display module 16 for controlling the main display unit 166 to display the first image IMG1, the backlight unit 167 to provide backlight, and the rotation mechanism 168 to rotate the optical projection element 164. Thereby, the first control unit 166 may control the main display module 16 to project the first image IMG1. The second control unit 34 is coupled to the backup display module 20 and controls the backup display module 20 to display the second image IMG2.

Moreover, the first control unit 32 and the second control unit 34 are coupled to a bus BUS of the car. The bus BUS is coupled to the various detectors of the car, such as the engine temperature sensor and the engine tachometer. The status information produced by the detectors detecting the car status may be transmitted to the bus BUS. Thereby, the first control unit 32 and the second control unit 34 may extract the car status information from the bus BUS. Then the first control unit 32 may transmit the car status information to the main display unit 166, so that the main display unit 166 may display the first image IMG1 according to the car information. In other words, the first image IMG1 includes the car status information. In addition, the second control unit 34 may control the backup display module 20 to display the second image IMG2 according to the car status information. According to the above description, the control circuit 30 may control the main display module 16 to display and project the first image IMG1 to be the virtual image and the backup display module 20 to display the second image IMG2 according to the car status information.

According to an embodiment of the present invention, the second control unit 34 is coupled to the first control unit 32. The second control unit 34 may transmit the car status information to the first control unit 32. In addition, the first control unit 32 and the second control unit 34 may be integrated to be a single chip.

Please refer again to FIG. 2. The first control unit 32 may detect the states of the rotation mechanism 168, the backlight unit 167, and the main display unit 166. If the first control unit 32 judges that the rotation mechanism 168, the backlight unit 167, or the main display unit 166 is in an abnormal state, it notifies the second control unit 34, for example, transmitting an abnormal signal to the second control unit 34, for driving the second control unit 34 to control the backup display module 20 to display the second image IMG2. Besides, the second control unit 34 will also detect the state of the first control unit 32. If the second control unit 34 judges that the first control unit 32 is in an abnormal state, it controls the backup display module 20 to display the second image IMG2. It means that the second control unit 34 controls the backup display module 20 to display the second image IMG2 according to the states of the main display module 16 and the first control unit 32.

Furthermore, the second control unit 34 may be coupled to the rotation mechanism 168, the backlight unit 167, and the main display unit 166 as well for detecting their states. When their states are abnormal, the second control unit 34 may control the backup display module 20 to display the second image IMG2. As shown in FIG. 1A, the backup display module 20 may display the basic car status information, such as the fuel quantity, the speed, and the temperature. It means that when the main display module 16 is in an abnormal state, the second image IMG2 displayed by the backup display module 20 includes at least a portion of the car status information for the driver for ensuring driving safety, so that the driver can, for example, drive to the vehicle maintenance depot for examining the main display module 16. The backup display module 20 is a simple display module, making its architectural complexity lower than that of the main display module 16. Besides, the power consumption of the backup display module 20 is lower than the power consumption of the main display module 16. Consequently, the stability of the backup display module 20 is higher than the stability of the main display module 16.

Please refer to FIG. 3A and FIG. 3B. The optical imaging device 10 according to the present invention projects the first image IMG1 or displays the second image IMG2. The first image IMG1 or the second image IMG2 is reflected by the windshield W to the human eye. The first image IMG 1 projected by theoptical imaging device 10 or the second image IMG2 displayed by the optical imaging device 10 is the inverted image. The first image IMG for the second image IMG2 becomes the positive image after reflection by the windshield W, and is reflected by the windshield W to the human eye. The main display unit 166 displays the first image IMG 1, which is the inverted image. The first image IMG 1 is reflected by the reflection mirror 162 to the optical projection element 164. Then the optical projection element 164 projects the first image light LG1 including the first image IMG1 toward the display window 142. In the backup display module 20, the second image light LG2 including the second image IMG2 is displayed directly, that the second image light LG2 is not reflected by optical elements.

As shown in FIG. 3A and FIG. 3B, the main display unit 166 of the optical imaging device 10 according to the present invention generates the first image IMG1, which is reflected by the reflection mirror 162 to the optical projection element 164. The optical projection element 164 projects the first image IMG1 according to a visual optical path P1. After the first image IMG1 is reflected by the windshield W, a reflection optical path P2 is formed, corresponding to the visual optical path P1. According to an embodiment of the present invention, the second image IMG2 is located on one side of the first image IMG1. For example, the second image IMG2 is located below or on both sides of the first image IMG1. In addition, because the second image IMG2 may include fewer car status information, the second image IMG2 is smaller than the first image IMG1, making the display region corresponding to the second image IMG2 smaller than the display region of the first image IMG1.

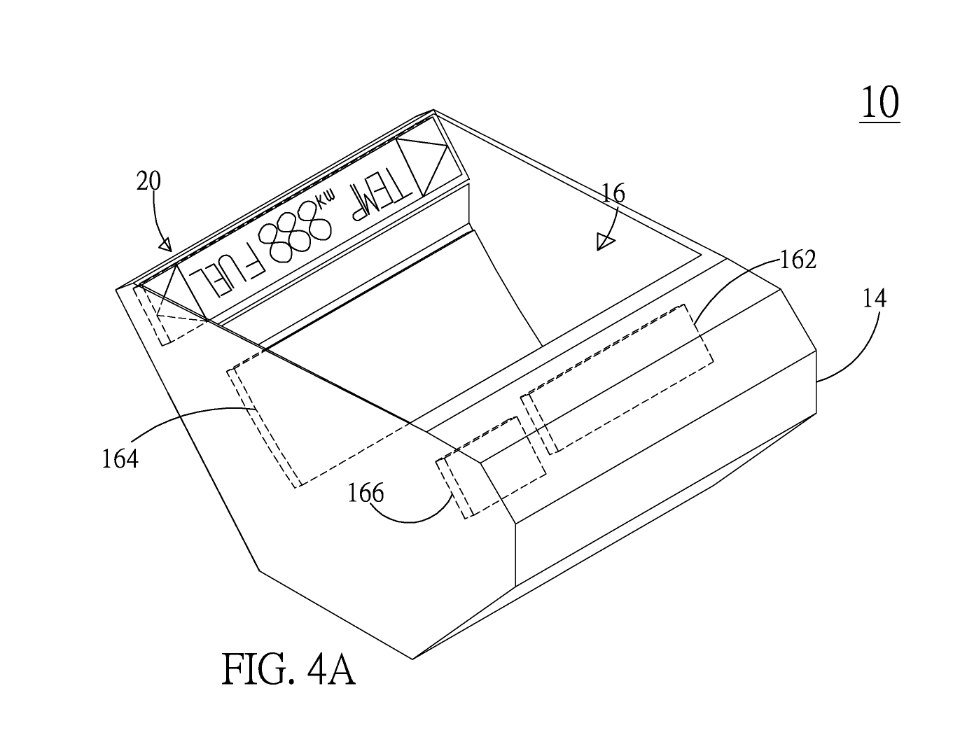

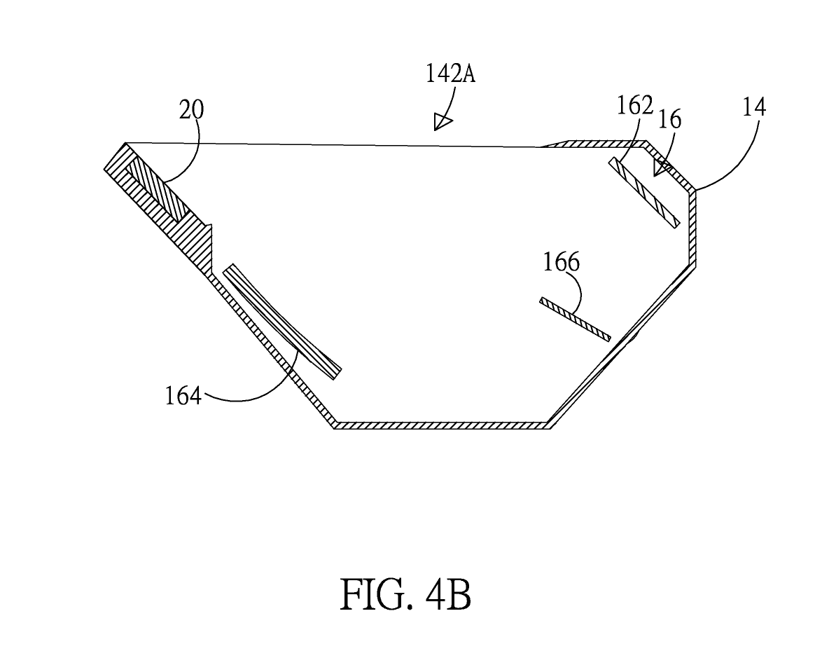

Please refer to FIG. 4A and FIG. 4B, which show a stereoscopic diagram and a cross-sectional view of the optical imaging device according to another embodiment of the present invention. The difference between the present embodiment and the previous one is that the backup display module 20 according to the previous embodiment (as shown in FIGS. 1A and 1B) is located outside the housing 14. Namely, the backup display module 20 is located outside the display window 142. Contrarily, the backup display module 20 according to FIGS. 4A and 4B is located inside the housing 14. In other words, the backup display module 20 is located inside the display window 142. The rest elements are identical to the description according to the previous embodiment.

Please refer again to FIGS. 1A, 3B, and 4A. Because the backup display module 20 also projects the second image IMG2 to the windshield W, the text displayed by the backup display module 20 is upside down, so that the second image IMG2 can be inverted to positive image after reflection by the windshield W. Likewise, the first image IMG1 projected by the main display module 16 is also upside down, so that the first image IMG1 can be inverted to positive image after reflection by the windshield W.

To sum up, the present invention provides an optical imaging device with backup display. When the main display module is abnormal, the backup display module still can display images to a driver's visual region for providing the car status information and hence ensuring the driving safety.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. An optical imaging device with backup display, comprising:
a housing;
a main display module, disposed in said housing, projecting a first image to be a virtual image; and
a backup display module, disposed in said housing, displaying a second image, and said second image being a real image.

2. The optical imaging device with backup display of claim 1, wherein said main display module includes:
a main display unit, disposed in said housing, and displaying said first image;
a reflection mirror, disposed in said housing; and
an optical projection element, disposed in said housing, and located on a reflection path of said reflection mirror;
where said reflection mirror reflects said first image to said optical projection element and said optical reflection element projects said first image to be the virtual image.

3. The optical imaging device with backup display of claim 2, wherein said optical projection element is a spherical mirror.

4. The optical imaging device with backup display of claim 1, further comprising a control circuit, coupled to said main display module and said backup display module, controlling said main display module to project sad first image, and controlling said backup display module to display said second image.

5. The optical imaging device with backup display of claim 4, wherein said control circuit controls said main display module to display said first image and project said first image and said backup display module to display said second image according to a car status information; said first image includes said car status information; and said second image includes at least a portion of said car status information.

6. The optical imaging device with backup display of claim 4, wherein said control circuit detects the state of said main display module; and when said min display module is abnormal, said control circuit controls said backup display module to display said second image.

7. The optical imaging device with backup display of claim 4, wherein said control circuit includes:
a first control unit, coupled to said main display module, and controlling said main display module to project said first image; and
a second control unit, coupled to said backup display module, and controlling said backup display module to display said second image.

8. The optical imaging device with backup display of claim 7, wherein said second control unit controls said backup display module to display said second image according to the state of said main display module and the state of said first control unit.

9. The optical imaging device with backup display of claim 8, wherein said second control unit detects the state of said main display module and the state of said first control unit; and when said main display module is in an abnormal state or said first control unit is in an abnormal state, said second control unit controls said backup display module displays said second image.

10. The optical imaging device with backup display of claim 1, wherein the power consumption of said backup display module is lower than the power consumption of said main display module.
